(19) United States
(12) Patent Application Publication
(10) Pub. No.: US 2022/0136845 A1
(43) Pub. Date: May 5, 2022

(54) MAP VERIFICATION METHOD, MAP VERIFICATION SYSTEM, AND VEHICLE-MOUNTED CONTROL DEVICE

(71) Applicant: Hitachi Astemo, Ltd., Hitachinaka-shi, Ibaraki (JP)

(72) Inventor: Masahiro KASHIMURA, Hitachinaka-shi (JP)

(73) Assignee: Hitachi Astemo, Ltd., Hitachinaka-shi, Ibaraki (JP)

(21) Appl. No.: 17/431,641

(22) PCT Filed: Feb. 5, 2020
(86) PCT No.: PCT/JP2020/004241

§ 371 Date: Aug. 17, 2021

(30) Foreign Application Priority Data
Mar. 12, 2019 (JP) 2019-044892

(51) Int. Cl. G01C 21/34; G01C 21/30; G05D 1/00; G05D 1/02

(52) U.S. Cl. CPC G01C 21/3446; G01C 21/30; G05D 2201/0213; G05D 1/0088; G05D 1/0212; G01C 21/3407

(57) ABSTRACT

A loss of map information is verified in a short time. Provided is a map verification method in which an arithmetic operation device verifies map data distributed to a control device mounted on a vehicle, wherein the arithmetic operation device executes: a step of searching for an end point of a link included in the distributed map data and existing within a predetermined range in a vicinity of the vehicle; and a step of determining whether there is a loss in the distributed map data in accordance with a result of collation as to whether the searched end point is a true end point.

### TECHNICAL FIELD

The present invention relates to a map verification system.

### BACKGROUND ART

Importance of a map referred to in automatic driving of a vehicle has been higher.

Background art of the present technical field includes the following prior art. PTL 1 (Japanese Patent Application Laid-Open No. 2018-18423) describes a control device including: a position information acquisition unit that acquires position information of a moving body capable of automatic driving; a map information acquisition unit that acquires map information and update information including information on an update area that is an area whose data has been changed by updating the map information; a determination unit that determines whether or not the moving body has approached the update area on the basis of the position information and the update information; and a signal output unit that outputs a switching instruction signal for instructing the moving body to switch from automatic driving to manual driving when it is determined that the moving body has approached the update area (see Abstract).

In addition, PTL 2 (Japanese Patent Application Laid-Open No. 2011-149786) describes a navigation device that, when an unconnected link is detected at a boundary of a plurality of areas used for searching for a route to a destination, determines that update is necessary and urges update of map data, so that it is possible to automatically determine whether or not update of map data is necessary more accurately when the route to the destination is searched for, and urges the update of the map data when it is determined that the update is necessary (see Abstract).

### CITATION LIST

### Patent Literature

PTL 1: JP 2018-18423 A
PTL 2: JP 2011-149786 A

### SUMMARY OF INVENTION

### Technical Problem

In the technique described in PTL 1, since a control unit determines whether or not the automatic driving is possible using the map information acquired from a map storage unit, the map information acquired from the map storage unit needs to be accurate. However, when the map information is transferred from the map storage unit to the control unit, a part of the map information may be lost. The loss of the map information hinders accurate automatic driving. However, verification as to whether the map data received by the control device (ECU) is correct has not been taken into consideration. Therefore, verification of incompleteness of the map information is required.

In order to verify the map information, a map is created from the acquired map information at a position of an own vehicle where the map information has been acquired, and it is possible to confirm that there is no loss by matching all shape coordinates. However, when matching of all the shape coordinates is confirmed every time the map information is acquired, it takes a huge amount of time to verify the map information, which hinders reduction in development time of the control device. In an actual vehicle, real-time verification of the map information acquired by the control device during automatic driving control (traveling) may be necessary.

An object of the present invention is to verify a loss of map information in a short time.

### Solution to Problem

A representative example of the invention disclosed in the present application is as follows. That is, provided is a map verification method in which an arithmetic operation device verifies map data distributed to a control device mounted on a vehicle, wherein the arithmetic operation device executes: a step of searching for an end point of a link included in the distributed map data and existing within a predetermined range in a vicinity of the vehicle; and a step of determining whether there is a loss in the distributed map data in accordance with a result of collation as to whether the searched end point is a true end point.

### Advantageous Effects of Invention

According to one aspect of the present invention, a loss in acquired map information can be confirmed in a short time. Problems, configurations, and effects other than those described above will be clarified by the following description of embodiments.

### BRIEF DESCRIPTION OF DRAWINGS

FIG. 1 is a diagram showing a configuration of a map verification system according to a first embodiment.

FIG. 2 is a flowchart of map verification processing according to the first embodiment.

FIG. 3 is a flowchart of end point search processing.

FIG. 4 is a diagram showing a configuration of map data.

FIG. 5 is a diagram showing a configuration of a vehicle control system according to a second embodiment.

FIG. 6 is a flowchart of map verification processing according to the second embodiment.

### DESCRIPTION OF EMBODIMENTS

### First Embodiment

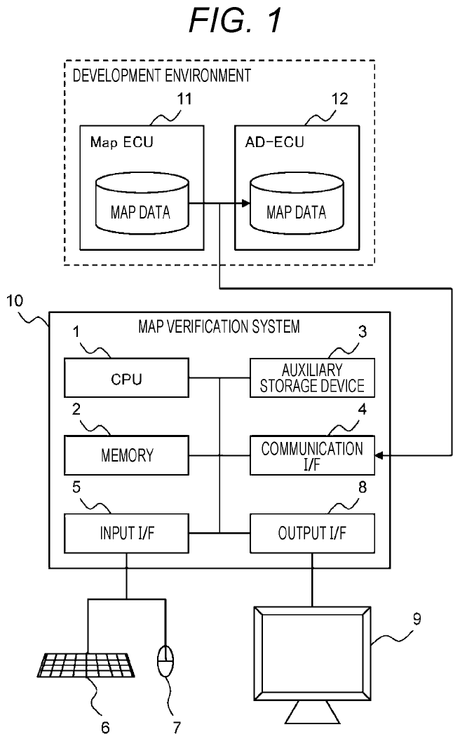

FIG. 1 is a diagram showing a configuration of a map verification system 10 according to a first embodiment of the present invention.

The map verification system 10 of the first embodiment is connected to a map ECU 11 and an automatic driving ECU 12. While the map ECU 11 and the automatic driving ECU 12 are connected by an in-vehicle network (e.g., Ethernet (registered trademark) or CAN) when the map verification system 10 is mounted on an actual vehicle, the map ECU 11 and the automatic driving ECU 12 are connected by a switch having a mirror port in a development environment. The map verification system 10 acquires map data transmitted from the map ECU 11 to the automatic driving ECU 12 from the mirror port of the switch, and verifies the map data.

A computer configuring the map verification system 10 has a processor (CPU) 1, a memory 2, an auxiliary storage device 3, and a communication interface 4. The computer may have an input interface 5 and an output interface 8. The processor (CPU) 1, the memory 2, the auxiliary storage device 3, the communication interface 4, the input interface 5, and the output interface 8 are connected accessibly by communication means such as a bus.

The processor 1 is an arithmetic operation device that executes a program stored in the memory 2. The processor 1 executes various programs to implement various functions of a server. Note that a part of processing performed by the processor 1 executing the program may be executed by another arithmetic operation device (e.g., FPGA or ASIC).

The memory 2 includes a ROM, which is a nonvolatile storage element and a RAM, which is a volatile storage device. The ROM stores an invariable program (e.g., BIOS) and the like. The RAM is a high-speed and volatile storage device such as a dynamic random access memory (DRAM), and temporarily stores the program executed by the processor 1 and data used when the program is executed.

The auxiliary storage device 3 is, for example, a large-capacity nonvolatile storage device such as a magnetic storage device (HDD) or a flash memory (SSD). In addition, the auxiliary storage device 3 stores the data used when the processor 1 executes the program, and the program executed by the processor 1. For example, the auxiliary storage device 3 stores master map data. The master map data is used for collation with the map data transmitted from the map ECU 11 to the automatic driving ECU 12. In addition, the program is read from the auxiliary storage device 3, loaded into the memory 2, and executed by the processor 1.

The communication interface 4 is a network interface device that controls communication with other devices according to a predetermined protocol.

The input interface 5 is an interface to which input devices such as a keyboard 6, a mouse 7, and a touch panel (not illustrated) are connected to receive input from an operator. The output interface 8 is an interface to which an output device such as a display device 9 or a printer (not illustrated) is connected to output an execution result of the program in a format that can be visually recognized by an operator.

The program executed by the processor 1 is provided to the server via a removable medium (CD-ROM, flash memory, etc.) or a network, and is stored in the nonvolatile auxiliary storage device 3, which is a non-transitory storage medium. Therefore, the map verification system 10 may have an interface that reads data from a removable medium.

The map verification system 10 may be a computer system configured on physically one computer or on a plurality of computers configured logically or physically, and may operate on a virtual computer constructed on a plurality of physical computer resources.

The map ECU 11 is one of electronic control devices mounted on a vehicle, and manages the map data by a CPU (arithmetic operation device) executing a predetermined program. The map data managed by the map ECU 11 is highly accurate map data that is used for automatic driving and driving support and includes information for each lane of a road. Note that the map data may include data of roads (e.g., a general road) other than roads (e.g., a highway, a motor way) that can provide automatic driving and driving support. A configuration example of the map data will be described later with reference to FIG. 4. The map ECU 11 determines whether the vehicle is on the posted road included in the map data by using the position information of the own vehicle measured by a GNSS receiver and external information acquired by a sensor, selects map data around the own vehicle, and transmits the map data to the automatic driving ECU 12. In addition, the map ECU 11 generates detailed route information (including travel lane information) for the vehicle to perform automatic driving using a route generated by a navigation system, and transmits the route information to the automatic driving ECU 12.

The automatic driving ECU 12 is one of electronic control devices mounted on a vehicle, and the CPU (arithmetic operation device) executes the predetermined program to thereby control traveling of the vehicle. That is, the automatic driving ECU 12 operates a steering wheel, an accelerator, and a brake using the external information acquired by the sensor (a camera, a radar, LIDER, or the like.) mounted on the vehicle in accordance with the route information generated by the map ECU 11. The automatic driving ECU 12 of the present embodiment provides at least one of an automatic driving function for causing the vehicle to travel without operation by a driver, and a driving support function for supporting the operation by the driver to cause the vehicle to travel on a specific road such as a highway or a motorway.

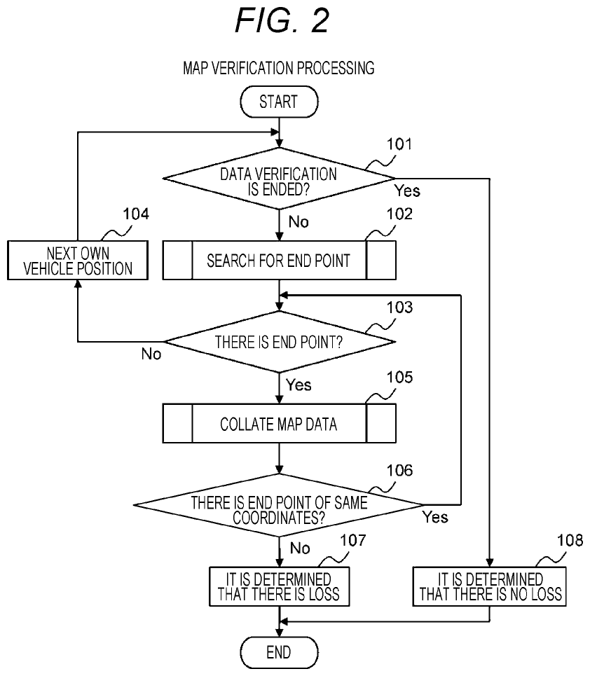

FIG. 2 is a flowchart of map verification processing according to the first embodiment.

First, the map verification system 10 (the processor 1) determines whether verification of all data has been completed (101). For example, the automatic driving ECU 12 acquires, from the map ECU 11, the map data within a range of a predetermined distance (e.g., 200 m) from the own vehicle, and determines that the data verification is ended when end point check is ended for all links included in the range. Then, if the verification ends with detecting no loss in all the data, it is determined that there is no loss (108), and the processing ends.

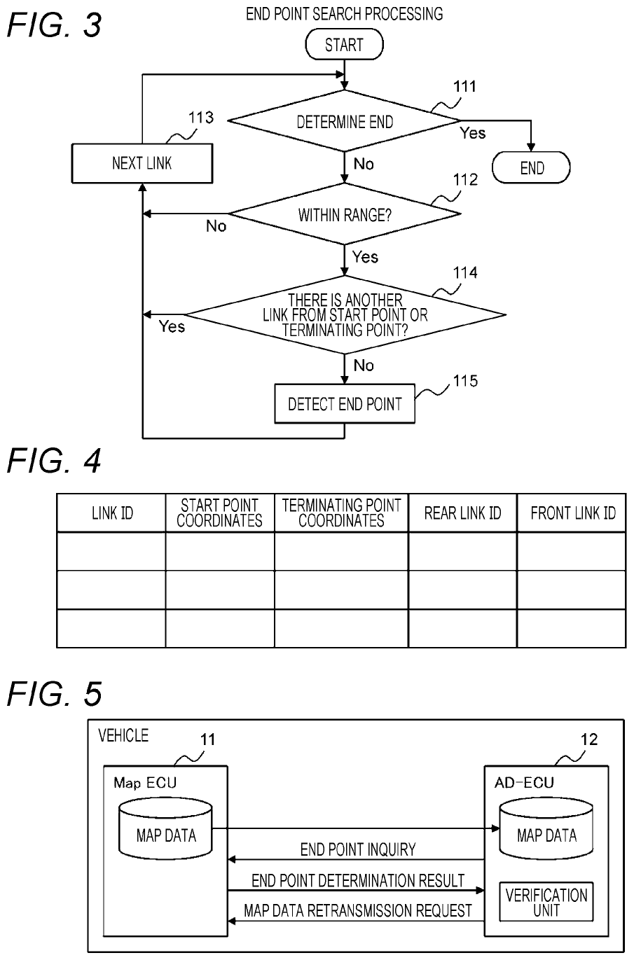

On the other hand, if there is unverified data, the end point search is executed (102). Details of end point search processing will be described later with reference to FIG. 3.

If no end point is detected by the end point search processing (No in 103), the processing proceeds to a next own vehicle position (104), and in step 101, it is determined whether all the data verification has been ended.

On the other hand, if an end point is detected by the end point search processing (Yes in 103), the detected end point is collated with the master map data (105). As a result of the collation, if there is an end point of the same coordinates in the master map data (Yes in 106), this point is a correct end point, so that the processing returns to step 103, and the end point check is continued. On the other hand, if there is no end point of the same coordinates in the master map data (No in 106), this point is not actually an end point, so that it is determined that there is a loss in the map data acquired by the automatic driving ECU 12 (107), and the map verification processing is ended. Note that, even after it is determined that there is a loss, the processing returns to step 103, and the unprocessed end point check may be continued.

FIG. 3 is a flowchart of the end point search processing.

First, the map verification system 10 (the processor 1) determines whether the search for the end points has been ended for all the links (111). If the end point determination is ended for all the links, the end point search processing is ended, and the processing returns to the map verification processing.

On the other hand, if the end point search has not been ended for a part of links, it is determined whether the links are within a range of a search target (112). Whether each of the links is within the range of the search target may be determined by determining whether the entire link is within the range, whether a part of the link (e.g., at least one end point) is within the range, whether two end points of the link are within the range, or the like.

As a result, if the link is out of the range of the search target, it is not necessary to search for the end point of the link, so that the processing proceeds to a next link (113) and returns to step 111 to process the next link. On the other hand, if the relevant link is within the range of the search target, it is determined whether there are another link having a start point position of the relevant link as a terminating point, and another link having a terminating point position of the relevant link as a start point (114).

If other links are connected at both the terminating point and the start point of the relevant link, the relevant link has no end point, so that the processing proceeds to a next link (113) and returns to step 111 to process the next link. On the other hand, when there is no link that is connected to the terminating point or the start point of the relevant link, the link has an end point, so that the detected end point is stored in the memory, and the processing proceeds to a next link (113), and the processing returns to step 111 to process the next link. When the end point is out of the range of the search target, it is not necessary to determine the presence or absence of a link connected to the relevant end point.

FIG. 4 is a diagram showing a configuration of the map data. The map data stored in the map ECU 11 and the automatic driving ECU 12 is highly accurate map data for automatic driving including information for each lane of a road, and is represented by a set of links defined on the basis of a lane ID, and the links are divided into segments. The segment is a unit for handling the map data, and the map data is transmitted from the map ECU 11 to the automatic driving ECU 12 in units of segments. That is, the map data includes the lane ID, start point coordinates (a latitude, a longitude, an altitude), end point coordinates (a latitude, a longitude, an altitude), a rear link ID connected from the start point of the relevant link to a front side in a traveling direction, a front link ID connected from the terminating point of the relevant link to the traveling direction side, and the like.

In the present embodiment, it is determined whether there is a loss in the distributed map data by determining whether the end point included in the distributed map data is a true end point. That is, since other links are usually connected before and after the link within a distribution range, it is possible to verify the loss of the link (map data) in a short time by verifying whether the link is interrupted and an end point is generated.

### Second Embodiment

In the first embodiment, the loss of the map data transmitted from the map ECU 11 to the automatic driving ECU 12 is verified in the development environment, but in a second embodiment, an automatic driving ECU 12 verifies a loss of map data transmitted from a map ECU 11 in a state of being mounted on a vehicle.

FIG. 5 is a diagram showing a configuration of a vehicle control system according to the second embodiment of the present invention.

The vehicle control system of the second embodiment includes the map ECU 11 and the automatic driving ECU 12, and the map ECU 11 and the automatic driving ECU 12 are connected by an in-vehicle network (e.g., Ethernet or CAN) (“Ethernet” is a registered trademark).

The map ECU 11 has the same configuration as that of the first embodiment, and transmits the managed map data to the automatic driving ECU 12.

The automatic driving ECU 12 has a verification unit 13 in addition to at least one of the automatic driving function and the driving support function described in the first embodiment. The verification unit 13 verifies the map data transmitted from the map ECU 11 to the automatic driving ECU 12, similarly to the map verification system 10 of the first embodiment. Note that the map verification system 10 of the first embodiment collates with the master map data when an end point is detected within a predetermined range, but the verification unit 13 of the second embodiment inquires of the map ECU 11 when an end point is detected within a predetermined range.

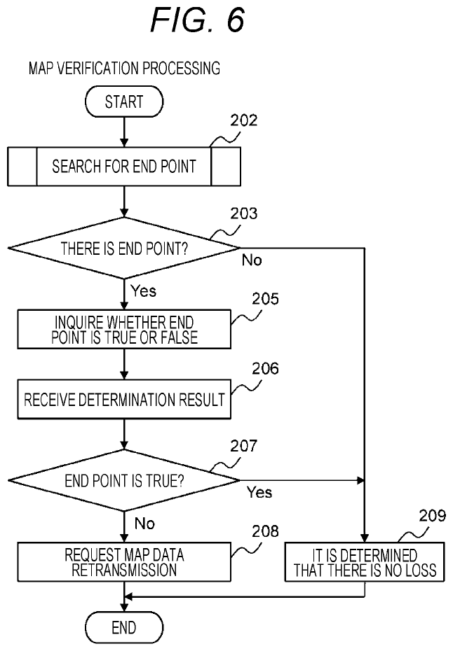

FIG. 6 is a flowchart of map verification processing according to the second embodiment. The map verification processing shown in FIG. 6 is executed every time the automatic driving ECU 12 receives the map data from the map ECU 11.

First, the verification unit 13 executes end point search (202). End point search processing may be the same as that in the first embodiment (FIG. 3).

If no end point is detected by the end point search processing (No in 203), it is determined that there is no loss (209), and the processing is ended.

On the other hand, when an end point is detected by the end point search processing (Yes in 203), coordinates of the detected end point are sent to the map ECU 11 to inquire whether the detected end point is a true end point (205). Map ECU 11 collates the coordinates received from the automatic driving ECU 12 with the map data, determines whether the coordinates indicate a true end point, and returns a determination result to the automatic driving ECU 12 (206).

When receiving the determination result from the map ECU 11 (206), the automatic driving ECU 12 determines whether the received determination result indicates that the end point is authentic (207). If the inquired end point is a true end point, it is determined that there is no loss (209), and the processing is ended.

On the other hand, if the inquired end point is not a true end point, the map ECU 11 is requested to retransmit the map data of the link connected to the relevant false end point (208).

In the case where a plurality of end points are detected by the end point search processing, it is determined that there is no loss if all of the plurality of end points are true end points (209). If one of the plurality of end points is not a true end point, retransmission of the map data of the links connected to the relevant false end point may be requested to the map ECU 11 (208).

In addition, the map ECU 11 may retransmit the map data when there is a loss in the map data without returning the determination result to the inquiry from the automatic driving ECU 12.

A retransmission unit of the map data may be a segment that divides the map data or data of the link related to the loss.

The automatic driving ECU 12 may execute the map verification processing again using the retransmitted map data, and as a result, if a false end point is detected, may further request retransmission of the map data. Then, if it is not determined that there is no loss in the map data even if the retransmission is performed the predetermined number of times, the automatic driving or the driving support may be stopped.

While the automatic driving ECU 12 has been described above as the second embodiment, the present invention can be applied to an electronic control device that operates using map data acquired from the map ECU 11 in place of the automatic driving ECU.

As described above, the map verification system 10 according to each of the embodiments of the present invention searches for the end point of the link included in the distributed map data and existing within a predetermined range in the vicinity of the vehicle, collates the searched end point with the master data, and determines that there is a loss in the distributed map data when the searched end point is not in the master data as a result of the collation. Therefore, the loss of the map data is determined by the end point of the link, so that verification time can be shortened. That is, if no end point of the link is detected, access to the master map data is unnecessary, so that the number of pieces of data to be compared with the master map data can be reduced, and the verification time can be shortened.

In addition, an in-vehicle control device (the automatic driving ECU 12) according to the embodiment of the present invention searches for the end point of the link included in the map data distributed from a distribution source control device (the map ECU 11) and existing within the predetermined range in the vicinity of the vehicle, inquires of the distribution source control device about the searched end point, and determines that there is a loss in the distributed map data when the searched end point is a false end point as a result of the inquiry, so that it is possible to verify the map information acquired by the control device in real time during the automatic driving control (during traveling).

Further, when it is determined that there is a loss in the distributed map data, the vehicle control device (automatic driving ECU 12) requests the distribution source control device (map ECU 11) to retransmit the map data including the relevant loss, so that the loss can be automatically corrected in a short time.

In addition, since the vehicle control device (automatic driving ECU 12) provides at least one function of the automatic driving and the driving support for causing the vehicle to automatically travel using the distributed map data, it is possible to accurately provide at least one function of the automatic driving and the driving support using map data without loss. In addition, since at least one of the functions of the automatic driving and the driving support is provided using the map data in which the loss is automatically corrected, stop frequency of the functions of the automatic driving and the driving support can be reduced.

Note that the present invention is not limited to the above-described embodiments, and includes various modifications and equivalent configurations within the gist of the appended claims. For example, the above-described embodiments have been described in detail in order to describe the present invention in an easy-to-understand manner, and are not necessarily limited to those having all the configurations described. Further, a part of configurations of one embodiments may be replaced with configurations of another embodiment. In addition, configurations of another embodiment may be added to configurations of one embodiment. Moreover, for a part of configurations of each embodiment, addition, deletion, or replacement of another configuration can be made.

In addition, a part or all of the above-described configurations, the functions, the processing units, the processing means, and the like may be realized by hardware, for example, by designing into an integrated circuit, or the like, or may be realized by software by a processor interpreting and executing a program for realizing each of the functions.

Information such as a program, a table, and a file for realizing each of the functions can be stored in a recording device such as a memory, a hard disk, and SSD (Solid State Drive), or a recording medium such as an IC card, an SD card, and a DVD.

In addition, control lines and information lines considered to be necessary for the description are shown, and not all control lines and information lines for implementation are necessarily shown. It can be considered that in reality, almost all the configurations are connected to one another.

### REFERENCE SINGS LIST

10 verification system
11 map ECU
12 automatic driving ECU

1. A map verification method in which an arithmetic operation device verifies map data distributed to a control device mounted on a vehicle,
wherein the arithmetic operation device executes:
a step of searching for an end point of a link included in the distributed map data and existing within a predetermined range in a vicinity of the vehicle; and
a step of determining whether there is a loss in the distributed map data in accordance with a result of collation as to whether the searched end point is a true end point.

2. A map verification system that verifies map data distributed to a control device mounted on a vehicle, the map verification system comprising:
an arithmetic operation device that executes predetermined processing; and a storage device connected to the arithmetic operation device,
wherein the storage device holds master data that is complete map data, and
the arithmetic operation device
searches for an end point of a link included in the distributed map data and existing within a predetermined range in a vicinity of the vehicle,
collates the retrieved end point with the master data, and
determines that there is a loss in the distributed map data, when the searched end point is not present in the master data as a result of the collation.

3. An in-vehicle control device mounted on a vehicle, the in-vehicle control device comprising:
an arithmetic operation device that executes predetermined processing; and a storage device connected to the arithmetic operation device,
wherein the arithmetic operation device
searches for an end point of a link included in the map data distributed from a distribution source control device and existing within a predetermined range in a vicinity of the vehicle,
inquires the distribution source control device about the searched end point, and
determines that there is a loss in the distributed map data, when the searched end point is not a true end point as a result of the inquiry.

4. The in-vehicle control device according to claim 3, wherein when it is determined that there is a loss in the distributed map data, the arithmetic operation device requests retransmission of the map data including the loss.

5. The in-vehicle control device according to claim 3, wherein the in-vehicle control device provides at least one function of automatic driving and driving support for causing the vehicle to automatically travel using the distributed map data.

6. The in-vehicle control device according to claim 4, wherein the in-vehicle control device provides at least one function of automatic driving and driving support for causing the vehicle to automatically travel using the distributed map data.
